(19) United States
(12) Patent Application Publication
(10) Pub. No.: US 2014/0180652 A1
(43) Pub. Date: Jun. 26, 2014

(54) METHOD FOR CONSTRUCTING A MODIFIED GEODESIC BELT

(71) Applicant: The Goodyear Tire & Rubber Company, Akron, OH (US)

(72) Inventors: Kiyoshi Ueyoko, Copley, OH (US); Luis Antonio Cabrera, Hartville, OH (US)

(73) Assignee: The Goodyear Tire & Rubber Company, Akron, OH (US)

(21) Appl. No.: 13/775,637

(22) Filed: Feb. 25, 2013

Related U.S. Application Data
(60) Provisional application No. 61/739,933, filed on Dec. 20, 2012.

(51) Int. Cl. G06F 17/50

(52) U.S. Cl. CPC G06F 17/5009
USPC 703/2

(57) ABSTRACT

A method of making a modified geodesic belt for a pneumatic tire is described. The ideal geodesic belt path is modified to select the centerline belt angle and to avoid excessive build up of the belt at the belt edges. The method includes the step of calculating the minimum three dimensional distance from one belt edge to the other belt edge preferably using dynamic successive approximation.

### FIELD OF THE INVENTION

The invention is directed to the field of tire manufacturing and tire construction.

### BACKGROUND OF THE INVENTION

It is known in the art to utilize zigzag belts in aircraft tires and truck tires. Zigzag belts are typically continuously woven from one belt edge to the other belt edge at a constant angle, with a turn around at the belt edges. A zigzag belt results in two layers of cord interwoven together with no cut belt edges. However, depending upon the tire size and other factors, the angle of the zigzag belt in the crown area is typically 10-14 degrees, with the turnaround angle at the belt edges typically around 90 degrees. It is however desired to have a higher angle at the centerline in order to improve wear, typically in the range of 15-45 degrees.

A geodesic belt construction has the belt cords arranged on a geodesic line on the tire's curved surface. On a curved surface the geodesic path is the least curvature or shortest distance between two points on a curved surface. A true geodesic path follows the special mathematical law: ρcosα=constant. A true geodesic belt has the advantage of a higher crown angle at the centerline as compared to the zigzag belt. The true geodesic belt also has the advantage of no shear stress, because it is the minimum path. Unlike the zigzag belt construction, the geodesic belt angle continuously varies such that the angle is high at the centerline, typically around 45 degrees, and is 180 degrees at the belt edges. Both the zigzag belt and the geodesic belt have an issue at the belt edges of accumulation. It is thus desired to provide an improved belt design which modifies the geodesic path to overcome the disadvantages of the geodesic belt. Thus for the foregoing reasons, it is desired to provide an improved method and apparatus for forming a belt with a modified geodesic path without the above described disadvantages.

### DEFINITIONS

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Breakers” or “Tire Breakers” means the same as belt or belt structure or reinforcement belts.

“Carcass” means a layer of tire ply material and other tire components. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated cords.

“Radial” and “radially” mean directions radially toward or away from the axis of rotation of the tire.

“Sidewall” means a portion of a tire between the tread and the bead.

“Laminate structure” means an unvulcanized structure made of one or more layers of tire or elastomer components such as the innerliner, sidewalls, and optional ply layer.

### BRIEF DESCRIPTION OF THE DRAWINGS

The invention will be described by way of example and with reference to the accompanying drawings in which:

FIG. 1 is a cross-sectional view of one half of a symmetrical aircraft tire.

FIG. 2 is a perspective view of a tire illustrating an ideal geodesic line 3 on the outer surface.

FIGS. 3a, 3b are front views of a tire with a modified geodesic belt.

FIG. 4 is a schematic view of a modified geoline from ψ=0 to ψ=360 degrees.

FIG. 5 is a side view simplified schematic of a tire building drum illustrating angle of drum rotation: ψ=0 to ψ=AG.

FIG. 6 is a process flow chart showing method steps of invention.

FIG. 7 illustrates the minimum path L in rectangular coordinates.

### DETAILED DESCRIPTION OF THE INVENTION

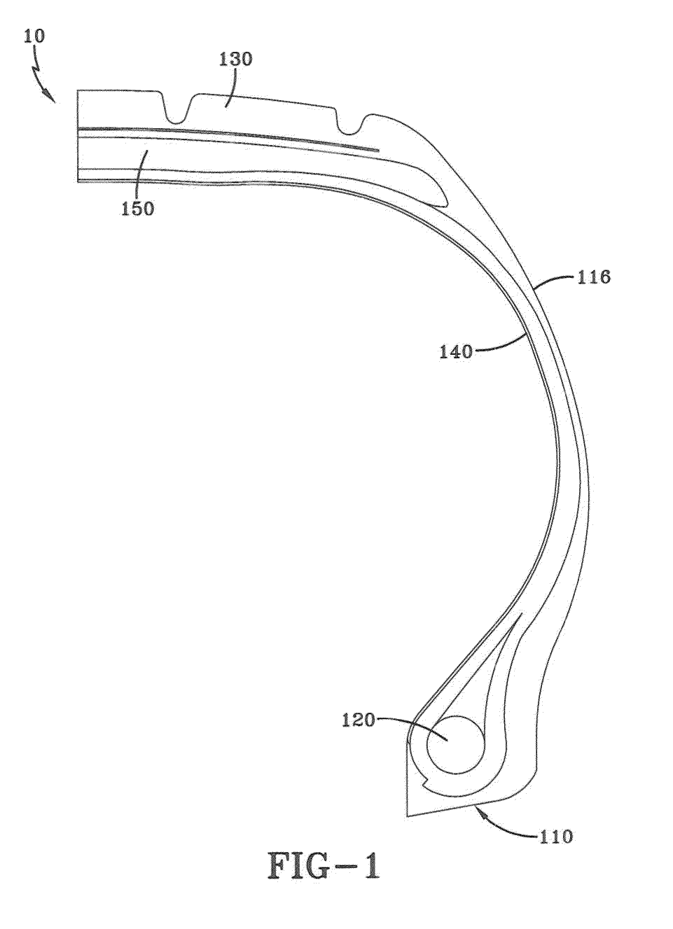

A cross-sectional view of a tire is shown in FIG. 1. As shown, the tire 100 may be representative of an aircraft tire and comprises a pair of opposed bead areas 110, each containing one or more beads 120 embedded therein. The tire 100 may further comprise sidewall portions 116 which extend substantially outward from each of the bead areas 110 in the radial direction of the tire. A tread portion 130 extends between the radially outer ends of the sidewall portions 116. Furthermore, the tire 100 is reinforced with a radial carcass 140 extending from one of the bead portions 120 to the other bead portion 120. A belt package 150 is arranged between the carcass 130 and the tread. The belt package has at least one modified geodesic belts as described in more detail, below.

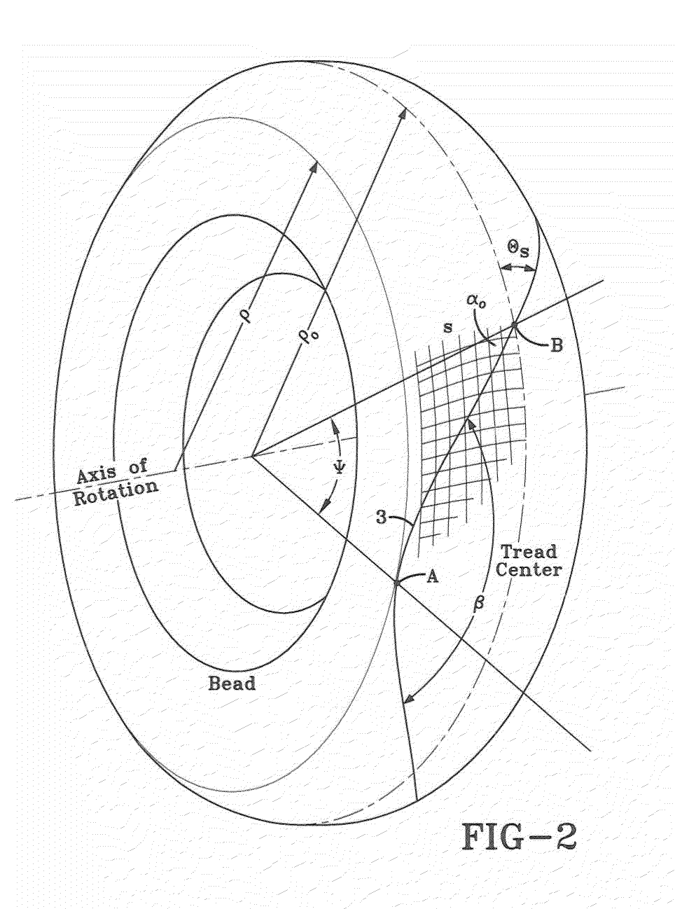

It is helpful to understand that a true geodesic line on a curved surface is the shortest 3 dimensional distance between two points in space or the least curvature. FIG. 2 illustrates line 3 which illustrates a belt having a true geodesic line. Note that the cord is tangent to the belt edge at point A. A true geodesic ply pattern follows the mathematical equation exactly: ρcos α=ρ₀ cos α₀, wherein ρ is the radial distance from the axis of rotation to the cord at a given location; α is the angle of the cord at a given location with respect to the mid-circumferential plane; and ρ is the radial distance from the axis of rotation of the core to the crown, andρ₀, α₀ is the radius and angle at the midcircumferential plane.

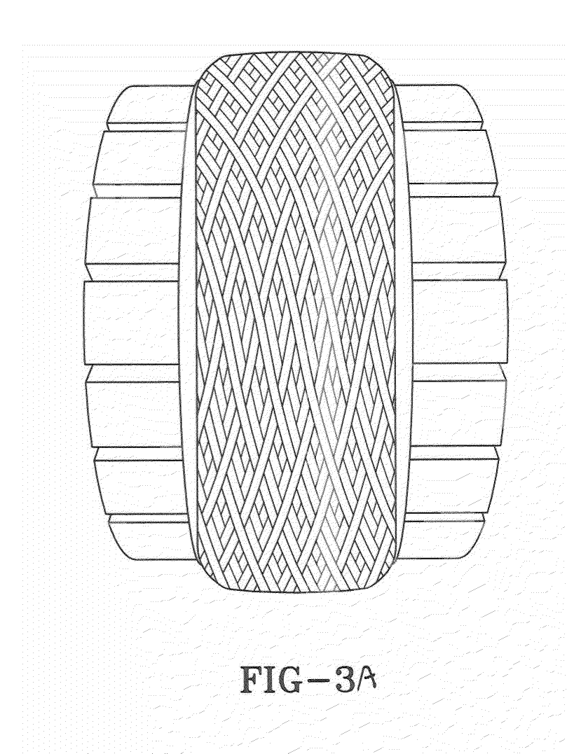

FIGS. 3a and 3b each illustrate a front view of a tire on a belt making machine constructed with a modified geodesic belt 150 of the present invention. The angle of the belt at the edges is slightly less than 180 degrees. Each belt looks different due to the selection of different parameters such as desired centerline angle θs. The geodesic belt is applied using a belt applier on a rotating B&T drum. The belt applier utilizes a mechanical arm applier (not shown) that translates in an axial direction from one belt edge shoulder to the other belt edge shoulder. A computer controller controls the arm position (x axis) coordinated with the speed of the B&T drum (ψ). The modified geodesic belt path 150 is determined from the following steps.

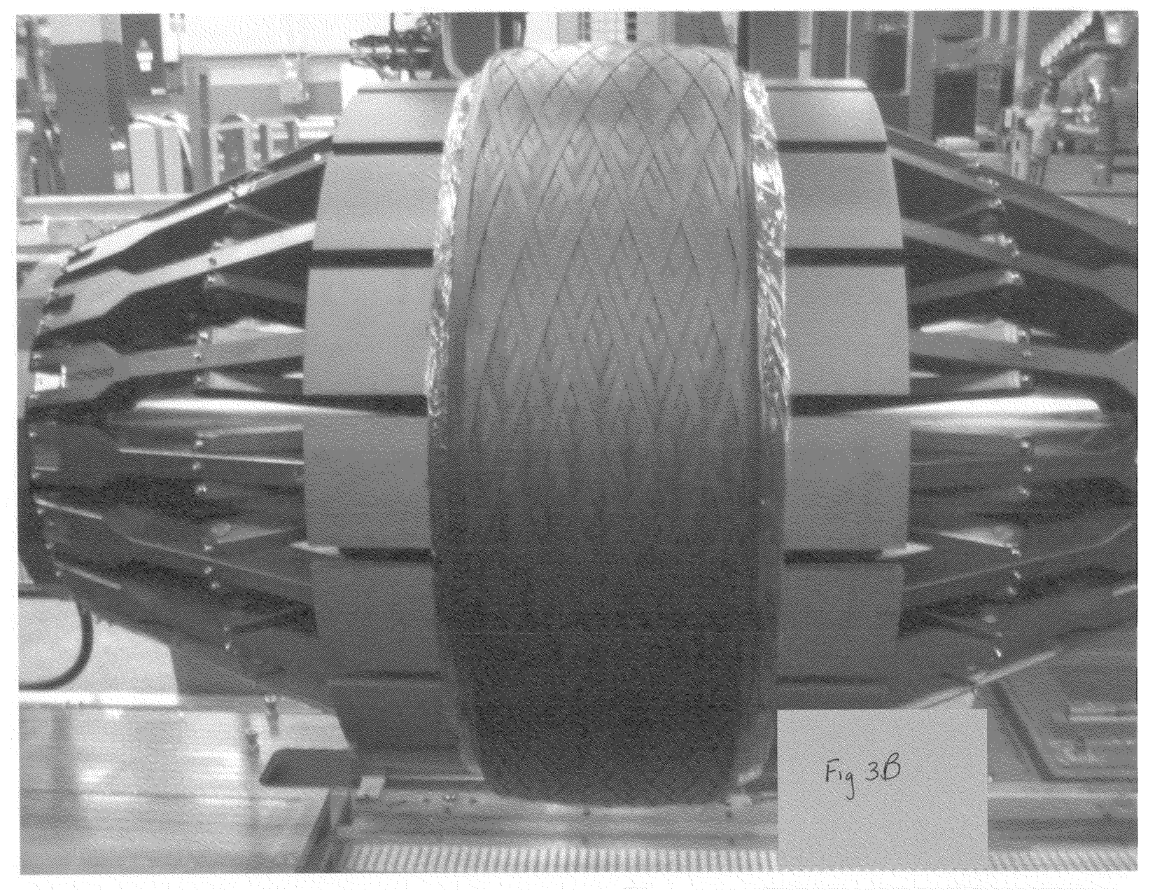

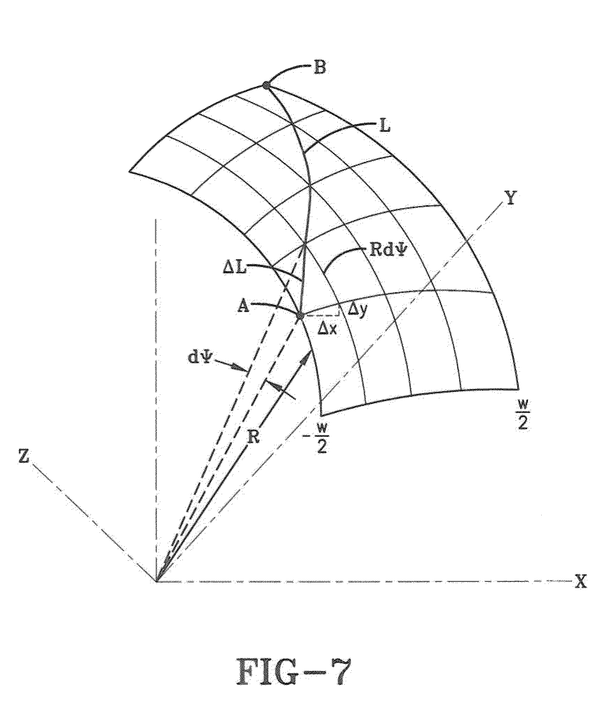

FIGS. 4 and 7 illustrates a modified geodesic path 150 according to the teachings of the invention. FIG. 4 illustrates the path if for 1 revolution from 0 degrees to Phi=360 degrees. For a true geodesic path, at each belt edge (W/2) the angle α=0 degrees so that the cord is tangent at the belt edge. The modified geodesic path of the invention deviates from an angle of zero at the belt edges in order to avoid excessive build up at the belt edges. The modified geodesic path also deviates from the angle at the centerline, so that a desired centerline angle θs may be obtained. For purposes of illustration, for an exemplary tire size, it is known that there are 20 geolines formed in 9 revolutions. Thus a geoline is formed in 0.45 revolutions for a true geodesic path. At each belt edge, the geoline is tangent to the belt edges (α=0), and the belt angle at the centerline is about 15.5 degrees. A geoline is defined as the three dimensional minimum path from one belt edge (point A on FIG. 4) to the opposite belt edge (point D, FIG. 4). Thus a belt would require multiple geolines in order to completely cover the tire belt surface, typically 80 geolines.

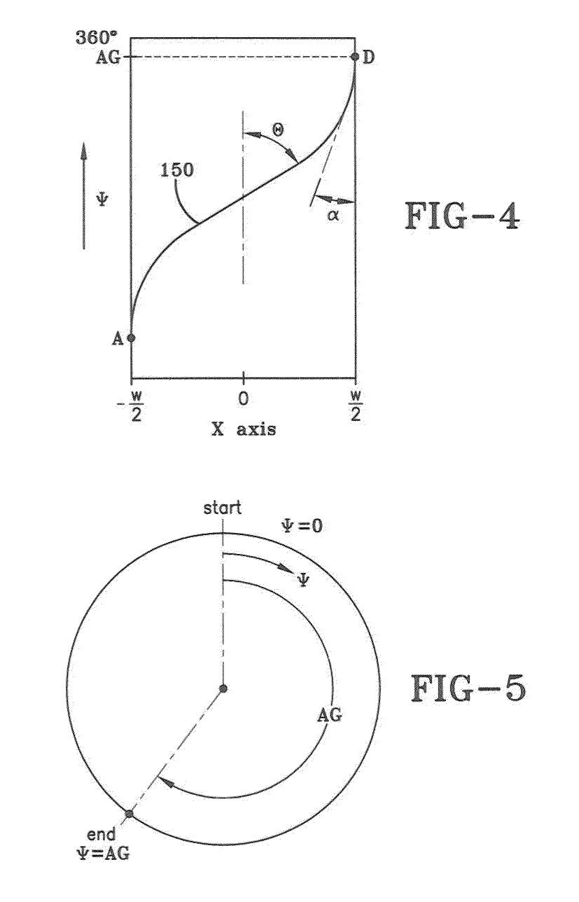

AG is defined as the change in angle ψ from the starting point A to the ending point D of the geoline as shown in FIG. 5. AG is set to have an initial value by specifying an initial NR value of 20, and an NG value of 30. The value of NG, AG will change as the iterative series of calculations are performed.

AG=360*NR/NG

Where NR =number of revolutions to form NG geolines

NG=number of geolines in the set, all sets are equal

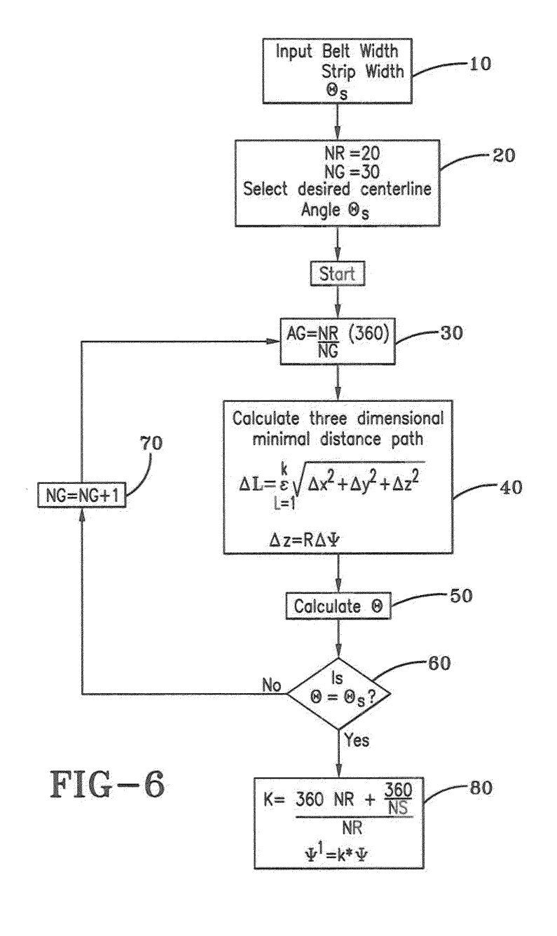

FIG. 6 illustrates the flow chart for outlining the steps to calculate a modified geoline 150 for a belt. For step 10, the belt width, strip width and desired centerline angle θs are input. For step 20, θs is set to the input value θs, and NR is set to 20, NG is set to 30. These values were determined from experience.

Where NR =number of revolutions in one set of geolines

NG=number of geolines in a set that have a starting point and ending point of zero degrees phi

For step 30, AG is determined from the following calculation:

AG=360*NR/NG

In step 40, the three dimensional minimum distance path L is determined for a geoline from the equation below, over the range from, X=−W/2 to W/2, phi=0 to AG

L=Σ(SQRT(X²+Y²+Z²)),

for i=1 to k

Where Z=R*δψ

In step 50, the angle θ is calculated at the centerline and compared with the input value θs. For step 60, if θ=θs? is not true, then step 70 is performed wherein NG is increased by the following formula:

NG=NG+ΔNG

Steps 30-70 are repeated until θ=θs.

Once θ=θs, then the remaining geolines for the set are determined using equations from step 40. Alternatively, once a geoline is calculated, the other remaining geolines can be determined by adding AG to the Phi values of the geoline data set.

A first data set is now known, wherein NR=20, and NG=70 was determined in this example. The first set of data points describing the minimal path are known in X, Y, Ψ coordinates. In order to fill the belt surface sufficiently, several sets are needed, typically in the range of 2 to 5 sets. Assume in this example four data sets are needed. In order to determine the starting point of sets two through four, the value K is computed from the equation below.

For four data sets, the first data set is preferably modified by a factor K in order to completely cover the belt area by the cords and to ensure that the second data set begins where the first data set ends. For four specified data sets, the ending point of the first data set will occur precisely at Ψ=90 degrees. Thus our first data set will start at Phi=0 and end at Phi=90 degrees. Set two will start at 90 degrees and end at 180 degrees. Set three will start at 180 degrees and end at 270 degrees. Set four will start at 270 degrees and end at 0/360 degrees.

K=[360*NR+360/NS])/NR

Where NS is number of data sets to be generated, in the example 4

In order to fill the belt, it is desired to have at least 4 data sets generated.

For the first data set, Ψ′=K*Ψ

Thus, the first data set has 70 geolines formed in 20 revolutions, wherein the data set begins at Ψ=0 and ends at Ψ=90. K is a multiplier which slightly stretches the data set to end precisely at an even interval such as 90 degrees. The second data set begins at Ψ=90 and ends at Ψ=180. This data set can be derived from the first data set by adding Ψ=Ψ+90, while the other data values stay the same. The third data set begins at Ψ=180 and ends at Ψ=270 degrees. This data set can be derived from the first data set by adding Ψ=Ψ+180, while the other data values stay the same. The fourth data set begins at Ψ=270 degrees and ends at Ψ=360 degrees. This data set can be derived from the first data set by adding Ψ=Ψ+270, while the other data values stay the same.

### Cord Construction

The cord may comprise one or more rubber coated cords which may be polyester, nylon, rayon, steel, flexten or aramid.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of forming a modified geodesic belt for a tire, the method comprising the steps of: selecting a desired centerline angle θs, calculating a three dimensional minimal distance path L from one belt edge to the other belt edge using the following equation:
a. L=Σ(SQRT(X²+Y²+Z²)),
for Ψ=0 to AG, Where Z=R*δψ;
b. Calculating θ at centerline of path
c. Determining a data set of points of the minimum path,
d. Incrementing NG if θ≠θs and then Calculating a new AG=NR/NG
e. Repeating steps a through c until θ about equals θs=/−Δ.

2. The method of claim 1 wherein a data set of X, Y, Rψ is determined from the minimal path.

3. The method of claim 2 wherein if θ about equals θs+/−Δ, then determining a factor K=[360*NR+360/NS])/NR.

4. The method of claim 3 wherein all the ψ data points are multiplied by factor k ψ=K*ψ.

5. The method of claim 1 wherein the belt is formed from a strip.

6. The method of claim 1 wherein the belt is formed from a continuous strip.

7. The method of claim 1 wherein the belt is formed from a nylon material.

8. The method of claim 1 wherein the belt is formed from an aramid material.

9. A method of forming a modified geodesic belt for a tire, the method comprising the steps of:
a. selecting a desired centerline angle θs,
b. calculating a three dimensional minimal distance path L from one belt edge to the other belt edge, and from ψ=0 to ψ=AG, where AG=NR/NG;
c. calculating centerline angle θ
d. modifying the angle ψ if θ is not within a desired range of θs
e. Repeating steps b through d until θ is not within a desired range of θs.

10. The method of claim 9 wherein a data set of X, Y, Rψ is determined from the minimal path.

11. The method of claim 9 wherein the three dimensional minimal distance path L from one belt edge to the other belt edge is determined using the following equation:
L=Σ(SQRT(X²+Y²+Z²)),
for ψ=0 to AG, Where Z=R*δψ.

12. The method of claim 10 wherein if θ about equals θs+/−Δ, then determining a factor K=[360*NR+360/NS])/NR.

13. The method of claim 12 wherein all the ψ data points are multiplied by factor k ψ=K*ψ.

14. The method of claim 1 wherein the belt is formed from a strip.

15. The method of claim 1 wherein the belt is formed from a continuous strip.

16. The method of claim 1 wherein the belt is formed from a nylon material.

17. The method of claim 1 wherein the belt is formed from an aramid material.
